(19) United States
(12) Patent Application Publication
(10) Pub. No.: US 2002/0143927 A1
(43) Pub. Date: Oct. 3, 2002

(54) Method and system for configuring a network element in a computer network

(76) Inventors: David A. Maltz, Los Altos, CA (US); Joshua G. Broch, Cupertino, CA (US); P. Bradley Dunn, Palo Alto, CA (US)

Correspondence Address: Joseph F. Hetz, Brinks Hofer Gilson & Lione, NBC Tower, Suite 3600, P.O. Box 10395, Chicago, IL, 60610, US

(21) Appl. No.: 09/771,156

(22) Filed: Jan. 26, 2001

Related U.S. Application Data
(60) Provisional application No. 60/251,811, filed on Dec. 7, 2000.

(51) Int. Cl. G06F 15/173; G06F 15/16; H04J 3/14

(52) U.S. Cl. 709/224; 709/235; 370/236; 709/246

(57) ABSTRACT

The preferred embodiments described herein provide a method and system for configuring a network element in a computer network. In one preferred embodiment, an instruction to configure a network element in a computer network is received. The instruction is converted into a form understood by the network element, and the converted instruction is sent to the network element. Other preferred embodiments are provided herein, and any or all of the preferred embodiments described herein can be used alone or in combination with one another.

This application claims the benefit of U.S. Provisional Application No. 60/251,811, filed Dec. 7, 2000, which is hereby incorporated by reference.

### BACKGROUND

Traffic Engineering

Many network operators are presented with the problem of efficiently allocating bandwidth in response to demand—efficiency both in terms of the amount of time that it takes the allocation to occur and the amount of resources that need to be allocated. One current solution is to sufficiently overprovision bandwidth, so that (1) provisioning only needs to be adjusted on a periodic basis (e.g., monthly/quarterly) and (2) unexpected fluctuations in the amount of traffic submitted to the network do not result in the “congestive collapse” of the network. When provisioning optical wavelengths, for example, carriers simply accept that they must greatly overprovision, adding more equipment to light up new fiber when the fiber has reached only a small fraction of its total capacity. There are some network planning and analysis tools that are available to carriers, but these are off-line tools. Carriers with optical networks are testing optical switches with accompanying software that provides point-and-click provisioning of lightpaths, but decisions on which lightpaths to set up or tear down are still being made off-line, and network-wide optimization or reconfiguration is still not possible with these tools. In other words, these tools do little to provide more efficient network configurations—carriers are still left with fairly static network architectures.

The use of optical switches allows the provisioning of end-to-end all optical paths. In such a network, Electrical-to-Optical and Optical-to-Electrical conversion is only done at the ingress and egress network elements of the optical network, rather than at every network element throughout the path. Reducing Optical-to-Electrical-to-Optical conversion (OEO) is advantageous because the equipment needed to do OEO conversion and the associated electrical processing is expensive, requiring vast amounts of processing and memory. This expense is only expected to increase as data rates increase to 10 Gb/s and beyond. Therefore it is expected that carriers will migrate toward an all-optical core.

At present, carriers cannot perform automatic provisioning or automated traffic engineering in their networks. The inability to automate these processes manifests itself in several ways. First of all, carriers frequently require 30 to 60 days to provision a circuit across the country from New York to Los Angeles, for example. The manual nature of this process means that it is not only costly in terms of manual labor and lost revenue, but it is also error prone. Secondly, as mentioned above, because carriers cannot provision their networks on demand, they often over-engineer them (often by a factor of 2 or 3) so that they can accommodate traffic bursts and an increase in the overall traffic demand placed on the network over a period of at least several months. This results in significant extra equipment cost, as well as “lost bandwidth”—bandwidth that has been provisioned but frequently goes unused. Finally, because traffic engineering and provisioning are manual processes, they are also error-prone. Network operators frequently mis-configure network elements resulting in service outages or degradation that again costs carriers significant revenue.

Several traffic engineering systems have been offered in the past. One such system is known as “RATES” and is described in P. Aukia, M. Kodialam, et al., “RATES: A Server for MPLS Traffic Engineering,” IEEE Network Magazine, March/April 2000, pp. 34-41. RATES is a system by which explicit requests for network circuits of stated bandwidth can be automatically routed through the network. RATES does not provide a way to reroute existing traffic, nor does it have a way to handle traffic for which an explicit request was not made. Further, RATES is unable to use traffic patterns to drive the routing or rerouting of traffic.

U.S. Pat. No. 6,021,113 describes a system for the pre-computation of restoration routes, primarily for optical networks. This system is explicitly based on the pre-computation of routes and does not compute routes in reaction to a link failure. Further, this system carries out the computation of restoration routes, which are routes that can be used to carry the network's traffic if a link should fail, prior to the failure of the link, and is not based on observed or predicted traffic patterns.

U.S. Pat. No. 6,075,631 describes an algorithm for assigning wavelengths in a WDM system such that the newly-assigned wavelengths do not clash with existing wavelength assignments and then transitioning the topology between the old state and the new state. The assignment of wavelengths is not made based on any kind of observed or predicted traffic pattern, and the algorithm only allocates resources in units of individual wavelengths.

Network Monitoring and Statistics Collection

Network monitoring and statistics collection is an important component of a carrier's network. Among other benefits, it allows network operators to make traffic engineering and resource provisioning decisions, to select the appropriate configuration for their network elements, and to determine when and if network elements should be added, upgraded, or reallocated. Presently, network operators deploy a multiplicity of systems in their networks to perform monitoring and data collection functions.

Equipment providers (e.g., Cisco, Fujitsu, etc.) each provide systems that manage their own network elements (e.g., IP router, SONET ADM, ATM Switch, Optical Cross-Connect, etc.). As a result, network operators are forced to operate one network monitoring/management system for each of the different vendor's equipment that is deployed in their network. Furthermore, if a variety of equipment types are obtained from each vendor, the network operator may need to have more than one monitoring system from a particular equipment vendor. For example, if both IP routers and SONET ADMs are purchased from the same vendor, it is possible that the network operator will have to use one monitoring system for the routers and one for the ADMs.

To date, no one has provided a hierarchical system that allows a network operator to monitor/collect statistics from all types of network equipment. Neither has anyone provided a system that allows a network operator to monitor/collect statistics from all types of networking equipment using a multiplicity of protocols. Providing an integrated system that interacts with multiple vendor's equipment and multiple types of equipment from each vendor would be a tremendous value-add to carriers, allowing them to get a complete picture of their network and its operation, rather than many fragmented or partial snapshots of the network. A system that can interact with network elements using a variety of protocols and that can monitor, collect statistics from, manage, or configure network elements from a variety of equipment vendors has not been provided to date.

Additionally, network operators (carriers) are increasingly finding that they need efficient ways to monitor and collect statistics from their network in order to verify that their network is performing adequately and to determine how best to provision their network in the future. Collecting and using network and traffic statistics from various network elements (e.g., routers, switches, SONET ADMs, etc.) is a very difficult problem. Carriers first need to determine what metrics are of interest to them, and then they must decide what data to collect and on what schedule to collect it so that they have these metrics to a useful degree of accuracy. Routers are being deployed with OC-192 or faster interfaces. The volume of data flowing through these routers makes it impractical to log or store information about all of the traffic flows being serviced by a particular router. Providing a statistics collection system that can filter and aggregate information from network elements, reducing the amount of raw data that needs to be stored by the carrier, will be increasingly important.

Network Reconfiguration

There is no system today that actually implements automatic network reconfiguration. While some systems, such as the NetMaker product by MAKE Systems, can produce MPLS configuration files/scripts for certain routers, no automation is provided. Additionally, the method and system for monitoring and manipulating the flow of private information on public networks described in U.S. Pat. No. 6,148,337 and the method and system for automatic allocation of resources in a network described in U.S. Pat. No. 6,009,103 do not disclose automatic network reconfiguration.

### SUMMARY

By way of introduction, the preferred embodiments described herein provide a method and system for configuring a network element in a computer network. In one preferred embodiment, an instruction to configure a network element in a computer network is received. The instruction is converted into a form understood by the network element, and the converted instruction is sent to the network element. Other preferred embodiments are provided herein, and any or all of the preferred embodiments described herein can be used alone or in combination with one another. These preferred embodiments will now be described with reference to the attached drawings.

### BRIEF DESCRIPTION OF THE DRAWINGS

FIG. 1 is an illustration of a computer network of a preferred embodiment comprising a plurality of nodes.

FIG. 2 is a block diagram of a preferred embodiment of the traffic management system.

FIG. 3 is an illustration of a traffic management system of a preferred embodiment.

FIG. 4 is a flow chart illustrating the chronological operation of a traffic management system of a preferred embodiment.

FIG. 5 is a flow chart illustrating how a TMS Algorithm of a preferred embodiment can be implemented.

FIG. 6 is an illustration of a computer network of a preferred embodiment in which a plurality of TMS Statistics Collection Servers in a respective plurality of points of presence (POPs) are coupled with a central TMS Statistics Repository.

FIG. 7 is an illustration of a TMS Statistics Repository of a preferred embodiment.

FIG. 8 is block diagram of a TMS Statistics Collection Server of a preferred embodiment.

FIG. 9 is an illustration of a traffic management system of a preferred embodiment and show details of a TMS Signaling System.

FIG. 10 is a block diagram of a TMS Signaling Server of a preferred embodiment having protocol-specific modules.

FIG. 11 is an illustration of a set of sub-modules that allow a TMS Statistics Collection Server to communicate with different types of network elements.

### DETAILED DESCRIPTION OF THE PRESENTLY PREFERRED EMBODIMENTS

The following articles discuss general traffic engineering and network concepts and are hereby incorporated by reference: “Traffic Engineering for the New Public Network” by Chuck Semeria of Juniper Networks, Publication No. 200004-004 September 2000, pages 1-23; “NetScope: Traffic Engineering for IP Networks,” Feldmann et al., IEEE Network, March/April 2000, pages 11-19; “MPLS and Traffic Engineering in IP Networks,” Awduche, IEEE Communications Magazine, December 1999, pages 42-47; “Measurement and Analysis of IP Network Usage and Behavior,” Caceres et al., IEEE Communications Magazine, May 2000, pages 144-151; and “RATES: A Server for MPLS Traffic Engineering,” P. Aukia et al., IEEE Network Magazine, March/April 2000, pages 34-41. The following U.S. patents also relate to computer networks and are hereby incorporated by reference: U.S. Pat. Nos. 6,148,337; 6,108,782; 6,085,243; 6,075,631; 6,073,248; 6,021,113; 6,009,103; 5,974,237; 5,948,055; 5,878,420; 5,848,244; 5,781,735; and 5,315,580.

Traffic Engineering Embodiments

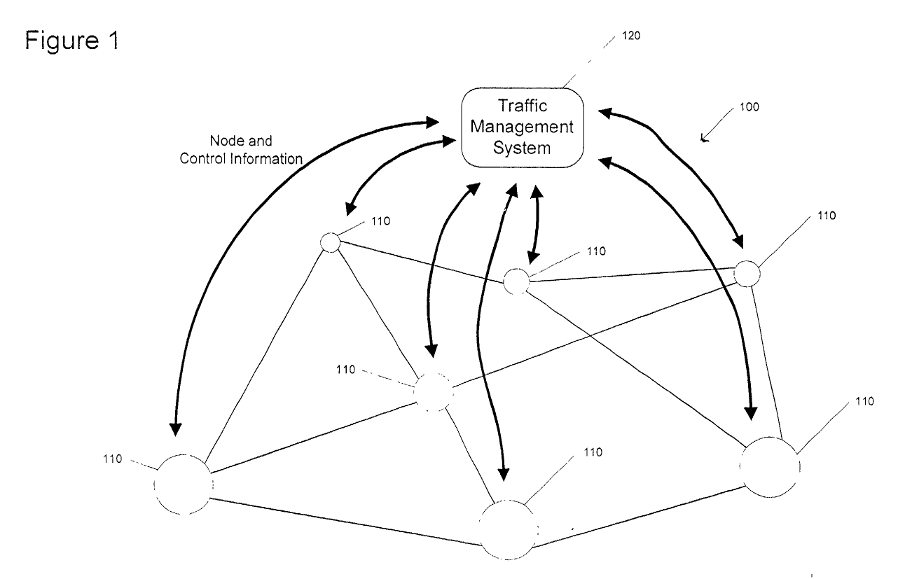

Turning now to the drawings, FIG. 1 is an illustration of a computer network 100 of a preferred embodiment comprising a plurality (here, seven) of locations 110, which are also known as Points of Presence (POPs) or nodes, each comprising at least one network element. As used herein, the term “network element” is intended to broadly refer to any device that connects to one or more network elements and is capable of controlling the flow of data through the device. Examples of network elements include, but are not limited to, routers, optical routers, wavelength routers, label switched routers (LSR), optical cross-connects, optical and non-optical switches, Synchronous Optical Network (SONET) Add-Drop Multiplexers (ADMs), and Asynchronous Transfer Mode (ATM) switches.

The data exchanged between nodes is preferably in digital form and can be, for example, computer data (e.g., email), audio information (e.g., voice data, music files), and/or video information, or any combination thereof. Data, which is also referred to as network traffic, is communicated between the nodes 110 of the network 100 via a path. As used herein, the term “path” is intended to refer to the way in which data is directed through one or more network elements. A path can, for example, be represented by protocol labels, such as those used within the Multi-Protocol Label Switching (MPLS) framework (used on Packet-Switch Capable (PSC) interfaces), time slots (used on Time-Division Multiplex Capable (TDMC) interfaces), wavelengths (used on Lambda Switch Capable (LSC) interfaces), and fibers (used on Fiber Switch Capable (FSC) interfaces). Paths can have other representations. Accordingly, a path can be an explicit labeling of the traffic (e.g., Label Switched Paths (LSPs)), the creation of a forwarding schedule in the network elements (e.g., a Time Division Multiplexing (TDM) switching table), and lightpaths. For simplicity, the network used to illustrate these preferred embodiments has a fixed physical connectivity (topology), and the path between nodes takes the form of label-switched paths (LSPs). Of course, other network topology and provisioning systems can be used, and the claims should not be read to include these elements unless these elements are explicitly recited therein.

FIG. 1 shows the nodes 110 of the network 100 coupled with a network (traffic) management system 120. As used herein, the term “coupled with” means directly coupled with or indirectly coupled with through one or more named or unnamed components. In this preferred embodiment, the traffic management system 120 automatically directs data in the computer network 100 (e.g., automatically provisions paths through the network) in response to traffic demands. As used herein, the term “automatically” means without human intervention (e.g., without the intervention of a network operator). Traffic demands can be determined by observations of existing traffic patterns and/or by explicit user requests to the network via a User-Network-Interface (UNI) (e.g., Optical Network Interface, OIF 2000.125). Traffic demands can also be determined by predicting future traffic patterns based on observed traffic patterns or on notification of traffic demands via a policy system such as the Common Object Policy Service (COPS). One or more ways of determining traffic demands can be used. Although not required, the traffic management system can monitor the traffic patterns in the automatically-provisioned path and automatically provision yet another path based on the monitored traffic demands. This provides a feedback functionality that repeatedly and dynamically provisions paths in the network.

The traffic management system can take any suitable form, such as one or more hardware (analog or digital) and/or software components. For example, the traffic management system can take the form of software running on one or more processors. The traffic management system can be distributed among the nodes in the network or implemented at a central location. A traffic management system having a logical central control as shown in FIG. 1 will be used to illustrate these preferred embodiments.

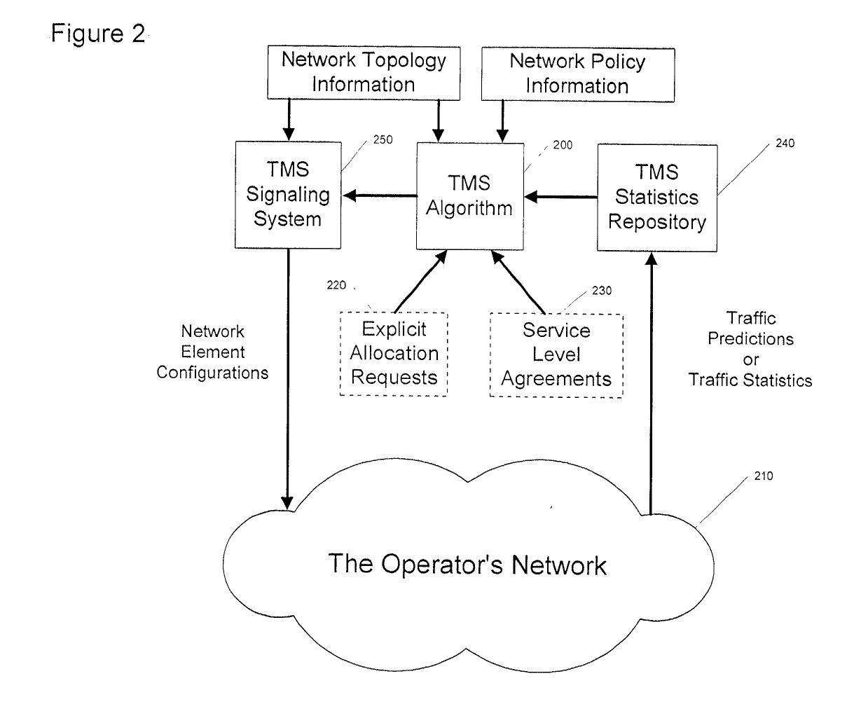

Turning again to the drawings, FIG. 2 is a block diagram of one presently preferred embodiment of the traffic management system (TMS). In this preferred embodiment, the traffic management system comprises a TMS Algorithm 200. The TMS Algorithm 200, which can be implemented with hardware and/or software, receives inputs that represent the traffic demand on the network 210. With these inputs and with knowledge of network topology and policy information, the TMS Algorithm 200 outputs network element configurations to automatically direct data based on the traffic demand. For example, the TMS can collect traffic information from all edge routers and switches in the network 210, predict bandwidth needs throughout the network 210, and send control information back to the network elements to reconfigure the network 210 to alter the forwarding of data so that network resources are better utilized (i.e., optimally utilized) based on the traffic demand on the network 210.

As shown in FIG. 2, one input to the TMS Algorithm 200 can be explicit allocations requests 220 made by customers of the operator's network 210 and/or service level agreements (SLAs) 230. Examples of methods for requesting service include the User Network Interface defined by the Optical Internetworking Forum (OIF) and the Resource Reservation Protocol (RSVP) defined by the Internet Engineering Task Force (IETF). The COPS system, also defined by the IETF, enables the carrier to enter into a database the policies the carrier wants enforced for the network. Some classes of these policies specify services the network should provide, and so these policies reflect the requests for service made to the carrier and can be treated by the TMS as requests for service. In many situations, however, there will not be an explicit request made for service for some or all of the data carried by the network. In these cases, the traffic demand is determined by observation of the existing traffic or statistics and/or predictions of future traffic demand based on those statistics. FIG. 2 shows traffic predictions and/or statistics being provided to the TMS Algorithm 200 through a component labeled TMS Statistics Repository 240 and shows network element configurations being outputted through a component labeled TMS Signaling System 250. It should be noted that the input and output of the TMS Algorithm 200 can be received from and provided to the operator's network 210 without these components, which will be described in detail below.

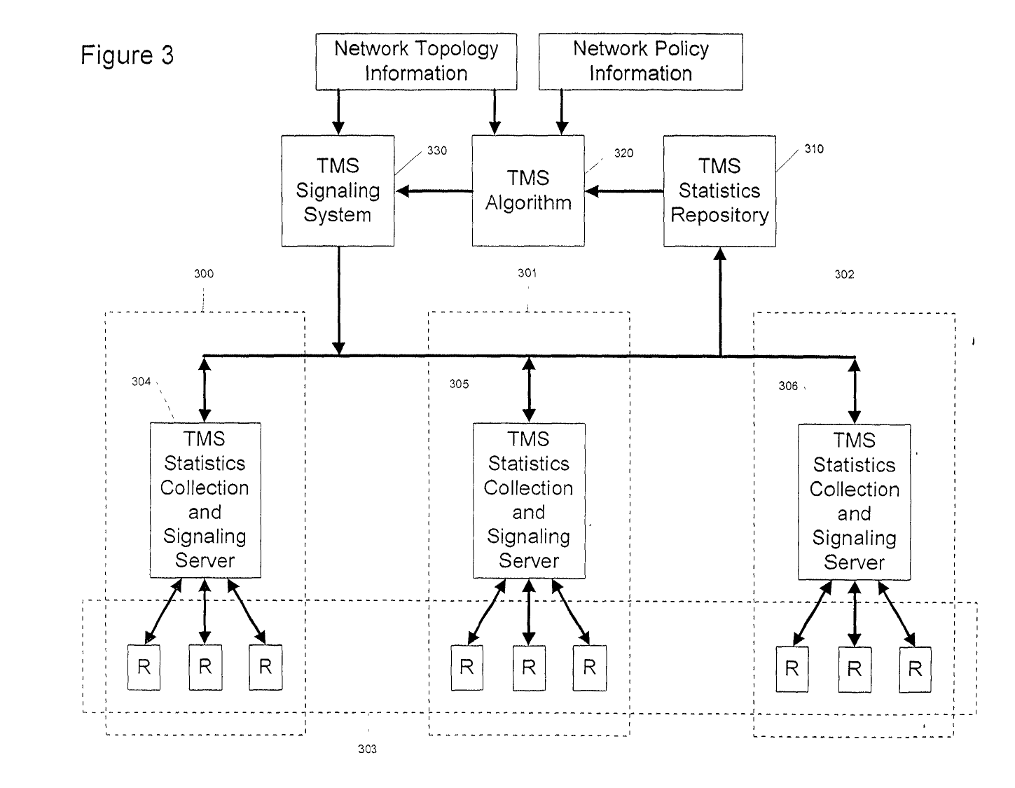

FIG. 3 provides an illustration of one presently preferred implementation of a traffic management system. As shown in FIG. 3, the operator's network comprises a plurality of network elements 303 located at Points of Presence (POPs) or nodes 300, 301, and 302. In the embodiment shown in FIG. 3, there are three routers R in each of the three POPs 300, 301, 302. It should be understood that a network can have more or fewer network elements and POPs and that the network elements are not necessarily routers. In this preferred embodiment, the traffic management system comprises a number of sub-systems: a plurality of TMS Statistics Collection and Signaling Servers 304, 305, 306, a TMS Statistics Repository 310, a TMS Algorithm 320, and a TMS Signaling System 330. It should be noted that while each TMS Statistics Collection and Signaling Server 304, 305, 306 is shown as a single entity, the TMS Statistics Collection and Signaling Server 304, 305, 306 can be implemented as two separate entities: a statistics collection server and a signaling server. While the TMS Statistics Collection and Signaling Servers 304, 305, 306 will be described in this section as one entity that performs both the statistics collection and signaling functions, in other sections of this document, the statistics collection and signaling functionality is distributed between two or more servers. Also, while FIG. 3 shows the TMS Statistics Collection and Signaling Servers 304, 305, 306 distributed throughout the network with one TMS Statistics Collection and Signaling Server 304, 305, 306 located at each POP 300, 301, 302, other arrangements are possible.

Each TMS Statistics Collection and Signaling Server 304, 305, 306 connects to the network elements (in this embodiment, routers R) within its local POP and collects and processes traffic data from the network elements. This information is fed back through the network to the TMS Statistics Repository 310, where the information is stored. The TMS Algorithm 320 processes the collected statistics stored in the TMS Statistics Repository 310 and determines the optimal network configuration. As mentioned above, the TMS Algorithm 320 can operate with traffic for which a request for service has been made in addition to traffic offered without a request by adding the requested demands to the demand determined by observing the pattern of traffic that is not covered by a request. Communication with the TMS Statistics Repository 310 can be via an “out-of-band” communication channel, or alternatively, an in-band channel within the network. Once the TMS Algorithm 320 determines the optimal network configuration, the TMS Signaling System 330 sends the optimal network configuration to each TMS Statistics Collection and Signaling Server 304, 305, 306 by generating the appropriate configuration information for each network element (in this embodiment, the routers R) and distributes this information to each TMS Statistics Collection and Signaling Server 304, 305, 306. The TMS Statistics Collection and Signaling Servers 304, 305, 306 then distribute this information to their respective routers R, thereby allowing the optimal network configuration determined by the TMS Algorithm 320 to be implemented.

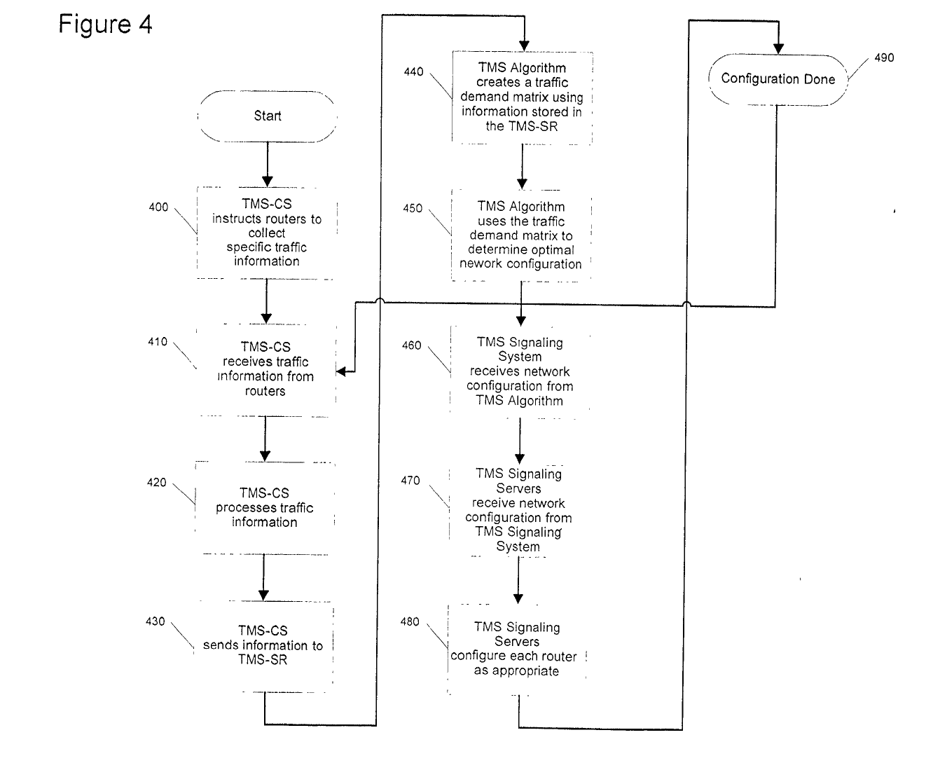

FIG. 4 is a flow chart showing the chronological operation of the Traffic Management System of FIG. 3. First, the TMS Statistics Collection and Signaling Servers 304, 305, 306 instruct the routers R to collect specific traffic information (act 400). The TMS Statistics Collection and Signaling Servers 304, 305, 306 receive traffic information from the routers R (act 410) and process the traffic information (act 420). The TMS Statistics Collection and Signaling Servers 304, 305, 306 then send the information to the TMS Statistics Repository 310 (act 430). The TMS Algorithm 320 creates a traffic demand matrix using information stored in the TMS Statistics Repository 310 (act 440) and uses the traffic demand matrix to determine an optimal network configuration (act 450) in conjunction with the Network Topology Information. The TMS Signaling System 330 receives the network configuration from the TMS Algorithm 320 (act 460). After the TMS Statistics Collection and Signaling Servers 304, 305, 306 receive the network configuration from the TMS Signaling System 330 (act 470), the TMS Statistics Collection and Signaling Servers 304, 305, 306 configure each router R as appropriate (act 480). When the configuration is done (act 490), the TMS Statistics Collection and Signaling Servers 304, 305, 306 again receive traffic information from the routers R (act 410), and the process described above is repeated.

As described above, one feature of this system is the real-time feedback loop. Measurements/statistics collected from the network (in addition to specific SLAs or requests from users) are repeatedly analyzed by the TMS Algorithm 320, which then adjusts the network configuration. The actual running of the TMS Algorithm 320 can be periodic (as shown in FIG. 4), or it can be event driven (e.g., when a new SLA is added to the system). Table 1 shows an example of the type of data in the records obtained from the network elements by the TMS Statistics Collection and Signaling Servers 304, 305, 306.

TABLE 1

| Contents | Description |
|---|---|
| Srcaddr | Source IP address |
| dstaddr | Destination IP address |
| nexthop | IP address of next hop router |
| input | SNMP index of input interface |
| output | SNMP index of output interface |
| dPkts | Packets in the flow |
| dOctets | Total number of Layer 3 bytes in the packets of the flow |
| First | SysUptime at start of flow |
| Last | SysUptime at the time the last packet of the flow was received |
| srcport | TCP/UDP source port number or equivalent |
| dstport | TCP/UDP destination port number or equivalent |
| pad1 | Unused (zero) bytes |
| tcp_flags | Cumulative OR of TCP flags |
| prot | IP protocol type (for example, TCP = 6; UDP = 17) |
| tos | IP type of service (ToS) |
| src_as | Autonomous system number of the source, either origin or |
| | peer |
| dst_as | Autonomous system number of the destination, either |
| | origin or peer |
| src_mask | Source address prefix mask bits |
| dst_mask | Destination address prefix mask bits |
| pad2 | Unused (zero) bytes |

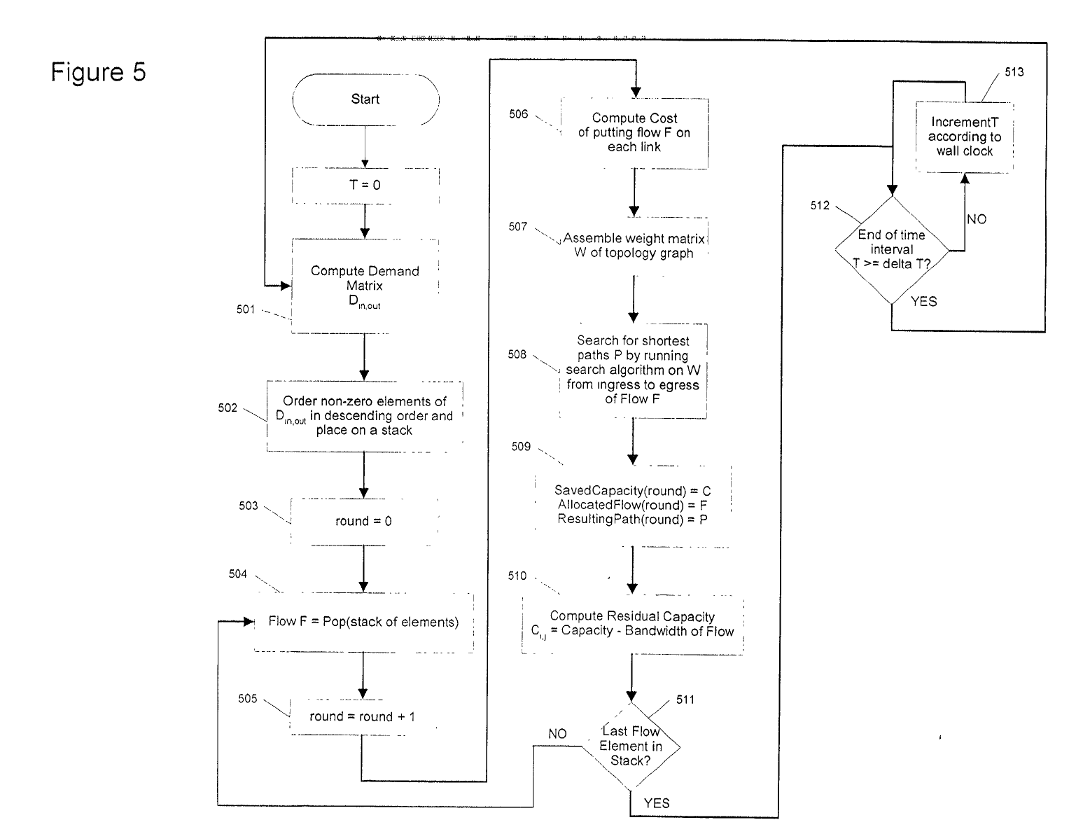

FIG. 5 shows one instance of how the TMS Algorithm 320 can be implemented. The algorithm is run every ΔT time period where ΔT is chosen such that it is greater than the time required to collect traffic information, process it, find new paths, and send control information to the routers or switches. The result of the algorithm's execution is a series of paths (P) that is to be set up to allow the predicted traffic to flow. In practice, the algorithm does not necessarily need to be periodic, and in fact can be triggered, for example, by a sufficiently large change in the traffic patterns.

Every time period, the algorithm, using traffic statistics collected from the network, determines all ingress-egress traffic flows, and uses this data to estimate the needed bandwidth during the next time period. The estimated bandwidth is also known as the traffic demand matrix, each element in the matrix representing the bandwidth demand between a network ingress point (in) and a network egress point (out). In act 501, the demand matrix is computed by taking the mean and variation of the traffic demand over the previous ten time periods and predicting the demanded traffic D_{in,out} as the mean plus three times the standard deviation. Other methods may be used such as using maximum load over observation period, max+variance, mean+α*variance, projected trend, or mean.

The non-zero elements of the demand matrix are then sorted in descending order (act 502). The elements, called flows, are placed on a stack and processed one at a time, starting with the largest first (act 504). Given each flow, the cost associated with putting that flow on a link between two nodes is computed (act 506). For each link in the network bounded by routers i and j, Cost(i,j,F) is computed as:

Cost(i,j,F)=1/(C_{i,j}−D_{in,out}), for C_{i,j}−D_{in,out}>0

Cost(i,j,F)=infinity, for C_{i,j}−D_{in,out}<=0

C_{i,j} is the capacity of each link (i,j)

1/(C_{i,j}−D_{in,out}) is the inverse of the link capacity minus the bandwidth requirement (demand) of the flow, F.

The initial capacity allocations for each link (i,j) can be found, for example, by running a routing protocol, such as OSPF-TE (Open Shortest Path First with Traffic Engineering extensions), that discovers not only the network topology, but also the bandwidth of each link.

In act 507, a weight matrix W is then instantiated, such that element (i,j) of the matrix W is Cost(i,j,F). W_{i,j} is then used to determine how to route each flow (F), by running a single source shortest path search on W from the ingress point of F (in) to the egress point of F (out) (act 508). Single source shortest path searches are well understood by those skilled in the art. The result of this search is the path, P. The intermediate states are saved into an array of partial results (act 509), and the residual capacity for each link (act 510), C_{i,j} is computed by removing the traffic demand of F from links (i,j) along the shortest path P. That is C_{i,j}=C_{i,j}−D_{in,out}.

Act 511 checks if all flows have been processed. If not, the next flow is popped off the stack and analyzed (act 504) as described above. Otherwise the algorithm waits for the end of the time interval, ΔT, and begins the entire network path optimization process again (act 501). It may be the case that there is a flow, F, that cannot be allocated a path because all possible paths in the network have been exhausted. In this case, the system can terminate and report the remaining flows that it is unable to allocate. In another embodiment, the system can backtrack to an earlier round, reorder the list, and resume running in order to find a more optimal solution. Earlier rounds are stored in the arrays SavedCapacity, AllocatedFlow, and ResultingPath (act 509).

Many other algorithms for computing the paths over which traffic demands should be routed are possible. Which algorithm will perform best depends on the conditions in the particular network to which this preferred embodiment is applied. The network engineer deploying this preferred embodiment may prefer to try the several algorithms described here and their variants and select the algorithm that performs best in their network. Alternatively, the system can be configured to automatically try several algorithms and then select the algorithm that produces the result that is able to satisfy the maximum number of flows.

The problem of computing paths to carry traffic demands can be reduced to the well known problem of bin-packing, for which many exact and approximate solutions are known. By reducing the network routing problem to the equivalent bin-packing problem and then solving the bin-packing problem using any known method, the network routing problem will also be solved.

Other classes of algorithms are also suitable. Examples of such algorithms follow. First, express the network optimization problem as a linear program where the traffic to be forwarded over each possible path through the network is represented as a variable (P1, P2, . . . Pn) for each path 1 to n. Constraint equations are written for each link to limit the sum of traffic flowing on the paths that traverse the link to the capacity of the link. The objective function is written to maximize the sum of traffic along all paths. Solving such a linear program is a well known process. Second, represent the configuration of the network as a multi-dimensional state variable, write the objective function to maximize the sum of the traffic carried by the network, and use genetic algorithms to find an optimal solution. Techniques for representing a network as a state variable and the use of a genetic algorithm can be adapted by one skilled in the art from the method in A Spare Capacity Planning Methodology for Wide Area Survivable Networks, by Adel Al-Rumaih, 1999, which is hereby incorporated by reference. Third, after representing the network as described in (2) above, using simulated annealing to find the optimal solution.

Once the path descriptions have been computed by the algorithm, the network is configured to implement these paths for the traffic. This can be achieved by converting the path descriptions into MPLS Label Switched Paths and then installing MPLS forwarding table entries and traffic classification rules into the appropriate network elements. As described earlier, it can also be achieved via configuring light paths or by provisioning any other suitable type of path.

One method to convert the path descriptions, P, determined by the algorithm into MPLS table entries is for the TMS software to keep a list of the labels allocated on each link in the network. For each link along each path, the software chooses an unallocated label for the link and adds it to the list of allocated labels. For routers on either end of the link, the TMS Signaling System (via the TMS Signaling Servers) creates an MPLS forwarding table entry that maps an incoming label from one link to an outgoing label on another link. Installing the resulting MPLS forwarding table configurations manually into a router is a well-understood part of using MPLS. Another method for the TMS Signaling System to create the paths uses either RSVP-TE or LDP to automatically set up MPLS label bindings on routers throughout the network.

In this embodiment, the MPLS table installation is automated using standard inter-process communication techniques by programming the TMS Signaling System to send the network element configurations commands over the network via SNMP or via a remote serial port device plugged into the network element's console port. Remote serial port devices acceptable for this purpose are commercially available. MPLS table configurations are loaded into all network elements simultaneously at the end of the ΔT time period. Since all TMS Signaling Servers running the traffic management software are synchronized at T=0, all control information is loaded into the network elements synchronously. As another possibility, the system can use the distribution system as taught in U.S. Pat. No. 5,848,244.

The TMS described above is not limited to using MPLS to construct paths, and it can manage many types of network elements beyond LSRs, for example, Lambda Routers, Wavelength Routers, and Optical Cross Connects (OXCs). A Lambda Router is a photonic switch capable of mapping any wavelength on an incoming fiber to any wavelength on an outgoing fiber. That is, a lambda router is capable of performing wavelength conversion optically. A Wavelength Router is a photonic switch capable of mapping any wavelength on an incoming fiber to the same wavelength on any outgoing fiber. That is, a wavelength router is not capable of optically performing wavelength conversion. It should be noted that a Wavelength Router may be implemented such that it photonically switches groups of wavelengths (wavebands), rather than single wavelengths. An Optical Cross Connect (OXC) is a photonic switch capable of mapping all of the wavelengths on an incoming fiber to the same outgoing fiber. That is, wavelengths must be switched at the granularity of a fiber.

The following will now describe how the TMS can be used with these optically based devices. It can also be used with all combinations of network elements, such as networks containing both LSRs and Lambda Routers. In an embodiment where network elements are comprised mostly of optical switches, such as a Wavelength Router, path descriptions determined by the algorithm, are converted into mirror positions at each optical switch along the path. An optical switch such as a Wavelength Router directs wavelengths using arrays of mirrors, however the techniques described below apply to any optical switch regardless of the physical switching mechanism. For example, they also apply to devices that perform a conversion of the traffic from optical form to electrical form and back to optical form, called OEO switches.

The output of the TMS Algorithm described above is a series of path descriptions. As described, these path descriptions can be expanded into MPLS forwarding table entries that associate incoming labels (Lin) on incoming interfaces (Iin) with an outgoing labels (Lout) on outgoing interfaces (Iout). Optical Switches use connection tables that associate incoming wavelengths (λin) on incoming fibers (FiberIn) with outgoing wavelengths (λout) on outgoing fibers (FiberOut). The paths determined by the TMS Algorithm can be used to control optical switches by maintaining in the TMS, a table that associates wavelengths with labels and associates fibers with interfaces. The paths output by the TMS Algorithm are thereby converted into mirror positions that instantiate the paths.

Each class of optical device is handled by a slightly different case:

Case 1: Lambda Router, wavelength conversion allowed.

Since these devices can map any (λin,FiberIn) combination to any (λout,FiberOut) combination, the (Lin,Iin) and (Lout,Iout) pairs calculated by the TMS Algorithm above are trivially and directly converted to (λin,FiberIn) and (λout,FiberOut) pairs used to configure the device.

Case 2: Wavelength Router, no wavelength conversion allowed These devices can map a (λ,FiberIn) combination to a restricted set of (λ,FiberOut) combinations that is constrained by the architecture of the device. Algorithms such as RCA-1 (Chapter 6 of “Multiwavelength Optical Networks”, Thomas E. Stern, Krishna Bala) can be used to determine paths in the absence of wavelength conversion.

Case 3: OXC, no wavelength conversion allowed

These devices can only map a (FiberIn) to a (FiberOut). Case 3 is even more restrictive than case 2, since there is no individual control of wavelengths, that is wavelengths must be switched in bundles. In this situation, an algorithm such as RCA-1 may be used to suggest all path configurations. Afterwards, the TMS would allow only those path configurations where all wavelengths received on a fiber FiberIn at a switch are all mapped to the same outgoing fiber, FiberOut. Path decisions that would require individual wavelengths on the same incoming fiber to be switched to different outgoing fibers would be considered invalid.

The conversion of Labels to Lambdas and Interfaces to Fibers can be performed by either the TMS Algorithm, or the TMS Signaling System. The installation of these paths into the optical switch connection tables is automated using the same methods described above that form the TMS Signaling System. For example, standard inter-process communication techniques can be used to send the network element configuration commands over the network via SNMP, CMIP or TL1, for example. Alternatively, remote serial port or remote console devices can be used to configure the network element. Another alternative is the use of RSVP-TE or LDP to automatically signal the setup of paths.

While in this example entirely new configuration information is created for each time period, a more sophisticated traffic management system can compute the minimal set of differences between the current configuration and the desired configuration and transmit only these changes to the network elements. The traffic management system can also verify that the set of minimal configuration changes it wishes to make are made in such an order as to prevent partitioning of the network or the creation of an invalid configuration on a network element.

As described, the TMS creates paths suitable for use as primary paths. An additional concern for some carriers is the provision of protection paths for some or all of the traffic on their network. As part of requesting service from the carrier, some customers may request that alternate secondary paths through the network be pre-arranged to reduce the loss of data in the event any equipment along the primary path fails. There are many different types of protection that can be requested when setting up an LSP (or other type of circuit (e.g., SONET)), however the most common are (1) unprotected, (2) Shared N:M, (3) Dedicated 1:1, and (4) Dedicated 1+1. If the path is Unprotected, it means that there is no backup path for traffic being carried on the path. If the path has Shared protection, it means that for the N>1 primary data-bearing channels, there are M disjoint backup data-bearing channels reserved to carry the traffic. Additionally, the protection data-bearing channel may carry low-priority pre-emptable traffic. If the path has Dedicated 1:1 protection, it means that for each primary data-bearing channel, there is one disjoint backup data-bearing channel reserved to carry the traffic. Additionally, the protection data-bearing channel may carry low-priority pre-emptable traffic. If the path has Dedicated 1+1 protection, it means that a disjoint backup data-bearing channel is reserved and dedicated for protecting the primary data-bearing channel. This backup data-bearing channel is not shared by any other connection, and traffic is duplicated and carried simultaneously over both channels.

For unprotected traffic, no additional steps are required by the TMS. For traffic demands resulting from a request for service requiring protection, the TMS Algorithm described above and in FIG. 5 is extended with the following steps. First, for a traffic flow requiring either 1:1 or 1+1 dedicated protection, one additional flow is placed on the stack in act 502, this flow having the same characteristics as the requested primary flow. The path that is eventually allocated for this additional flow will be used as the protection path for the requested flow. For traffic requiring N:M shared protection, M additional flows are placed on the stack in act 502, with each of the M flows having as characteristics the maximum of the characteristics of the requested N primary flows. Second, the cost function, Cost(i,j,F), in act 506 is extended to return the value infinity if F is a protection path for a flow which has already been allocated a path, and that already allocated path involves either i or j. For Dedicated 1+1 protection paths, the TMS Algorithm must output to the TMS Signaling System not only the path, but also additional information in the common format which will cause the TMS Signaling System to command the ingress network element to duplicate the primary traffic onto the secondary protection path. For Dedicated 1:1 and Shared N:M paths, the TMS Algorithm can output to the TMS-SS additional information which will cause it to command the network elements to permit additional best-effort traffic onto the secondary paths.

Hierarchical Collection and Storage of Traffic Information-Related Data Embodiments

The preferred embodiments described in this section present a method and system of hierarchical collection and storage of traffic information-related data in a computer network. By way of overview, traffic information is collected from at least one network element at a POP using a processor at the POP. Preferably, the local processor analyzes the traffic information and transmits a result of the analysis to a storage device remote from the POP. As used herein, the phrase, “analyzing the collected traffic information” means more than just aggregating collected traffic information such that the result of the analysis is something other than the aggregation of the collected traffic information. Examples of such an analysis are predicting future traffic demands based on collected traffic information and generating statistical summaries based on collected traffic information. Other examples include, but are not limited to, compression (the processor can take groups of statistics and compress them so they take less room to store or less time to transmit over the network), filtering (the processor can select subsets of the statistics recorded by the network element for storage or transmittal to a central repository), unit conversion (the processor can convert statistics from one unit of measurement to another), summarization (the processor can summarize historical statistics, such as calculating means, variances, or trends), statistics synthesis (the processor can calculate the values for some statistics the network element does not measure by mathematical combination of values that it does; for example, link utilization can be calculated by measuring the number of bytes that flow out a line card interface each second and dividing by the total number of bytes the link can transmit in a second), missing value calculation (if the network element is unable to provide the value of a statistic for some measurement period, the processor can fill in a value for the missing statistic by reusing the value from a previous measurement period), and scheduling (the processor can schedule when statistics should be collected from the network elements and when the resulting information should be transmitted to the remote storage).

Preferably, the local processor in this hierarchical system acts as a condenser or filter so that the number of bytes required to transmit the result of the analysis is less than the number of bytes required to transmit the collected traffic information itself, thereby reducing traffic demands on the network. In the preferred embodiment, the local processor computes a prediction of the traffic demand for the next time period AT and transmits this information, along with any other of the raw or processed statistics the operator has expressed a request for, to the remote storage device. In an alternate embodiment, the local processor transmits the collected traffic information and sends it to the remote storage device without processing such as filtering. In other embodiments, the remote storage device receives additional traffic information-related data from additional local processors at additional POPs. In this way, the remote storage device acts as a centralized repository for traffic information-related data from multiple POPs. Additionally, the local processor at a POP can collect traffic information from more than one network element at the POP and can collect traffic information from one or more network elements at additional POPS. Further, more than one local processor can be used at a single POP. It should be noted that the local processor may have local storage available to it, in addition to the remote storage. This local storage can be used by the processor to temporarily store information the processor needs, such as historical statistics information from network elements.

Once the data sent from the local processor at the POP is stored in the remote data storage device, the data can be further analyzed. For example, data stored in the storage device can be used as input to a hardware and/or software component that automatically directs data in response to the stored data, as described in the previous section. It should be noted that this preferred embodiment of hierarchical collection and storage of traffic information-related data can be used together with or separately from the automatically-directing embodiments described above.

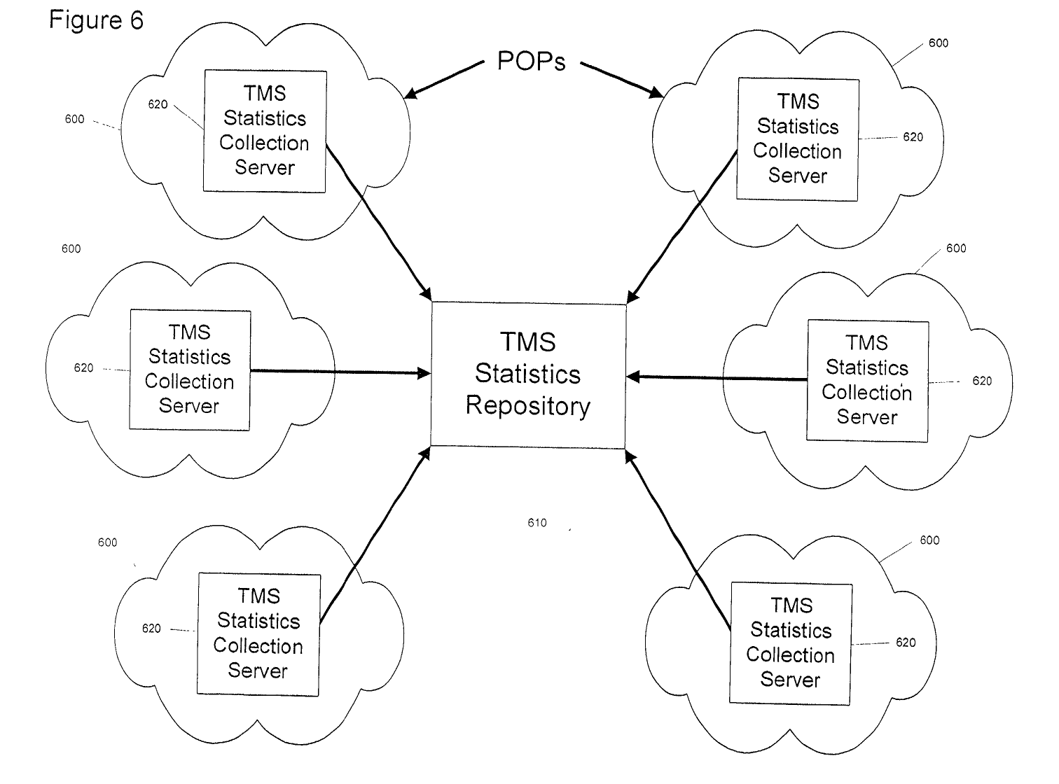

Turning again to the drawings, FIG. 6 is an illustration of one preferred implementation of this preferred embodiment. In this implementation, a plurality of POPs 600 in a computer network are coupled with a central TMS Statistics Repository 610 (the remote data storage device). Each POP comprises a respective TMS Statistics Collection Server 620 (the local processor) and a respective at least one network element (not shown). While a TMS Statistics Collection Server is shown in FIG. 6, it should be understood that the server can implement additional functionality. For example, as discussed above, the functionality of statistics collection can be combined with the functionality of the signaling in a single server (the TMS Collection and Signaling Server). In this preferred embodiment, the TMS Statistics Collection Server configures network elements to collect traffic information at its POPs, collects the traffic information, analyzes (e.g., processes, filters, compresses, and/or aggregates) the collected traffic information, and transmits a result of the analysis to the TMS Statistics Repository 610. Once the data is stored in the TMS Statistics Repository 610, it can be further analyzed, as described below. It should be noted that FIG. 6 may represent only a portion of an operator's network. For example, FIG. 6 could represent a single autonomous system (AS) or OSPF area. Data collected within this region of the network can be stored and processed separately from data collected in other areas.

Preferably, the TMS Statistics Collection Servers are included at various points in the network to collect information from some or all of the “nearby” network elements. For example, a network operator can place one TMS Statistics Collection Server in each POP around the network, as shown in FIG. 6. The exact topological configuration used to place the TMS Statistics Collection Servers in the network can depend upon the exact configuration of the network (e.g., the number of network elements at each POP, the bandwidth between the POPs, and the traffic load). While FIG. 6 shows one TMS Statistics Collection Server in each POP, it is not critical that there be one TMS Statistics Collection Server in each POP. A network operator can, for example, choose to have one TMS Statistics Collection Server per metro-area rather than one per POP. An operator can also choose to have multiple TMS Statistics Collection Servers within a single POP, such as when there are a large number of network elements within a POP.

Network operators may prefer to place the TMS Statistics Collection Servers close to the network elements that they are collecting information from so that large amounts of information or statistics do not have to be shipped over the network, thereby wasting valuable bandwidth. For example, the TMS Statistics Collection Server can be connected to the network elements via 100 Mbps Ethernet or other high speed LAN. After the TMS Statistics Collection Server collects information from network elements, the TMS Statistics Collection Server can filter, compress, and/or aggregate the information before it is transferred over the network or a separate management network to a TMS Statistics Repository at the convenience of the network operator. Specifically, such transfers can be scheduled when the traffic load on the network is fairly light so that the transfer of the information will not impact the performance seen by users of the networks. These transfer times can be set manually or chosen automatically by the TMS Statistics Collection Server to occur at times when the measured traffic is less than the mean traffic level.

Some analyses may place additional requirements on the TMS Statistics Collection Server. For example, when the TMS Statistics Collection Server is used to send traffic predictions derived from the collected traffic statistics rather than the statistics themselves, the TMS Statistics Collection Server may be required to locally store statistics for the time required to make the predictions. The TMS Statistics Collection Server can, for example, collect X bytes of network statistics every T seconds. If predictions are formed by averaging the last 10 measurements, then the TMS Statistics Collection Server can be equipped with enough storage so that it can store 10*X bytes of network information. Such a prediction would probably not result in any significant increase in the required processing power of the TMS Statistics Collection Server.

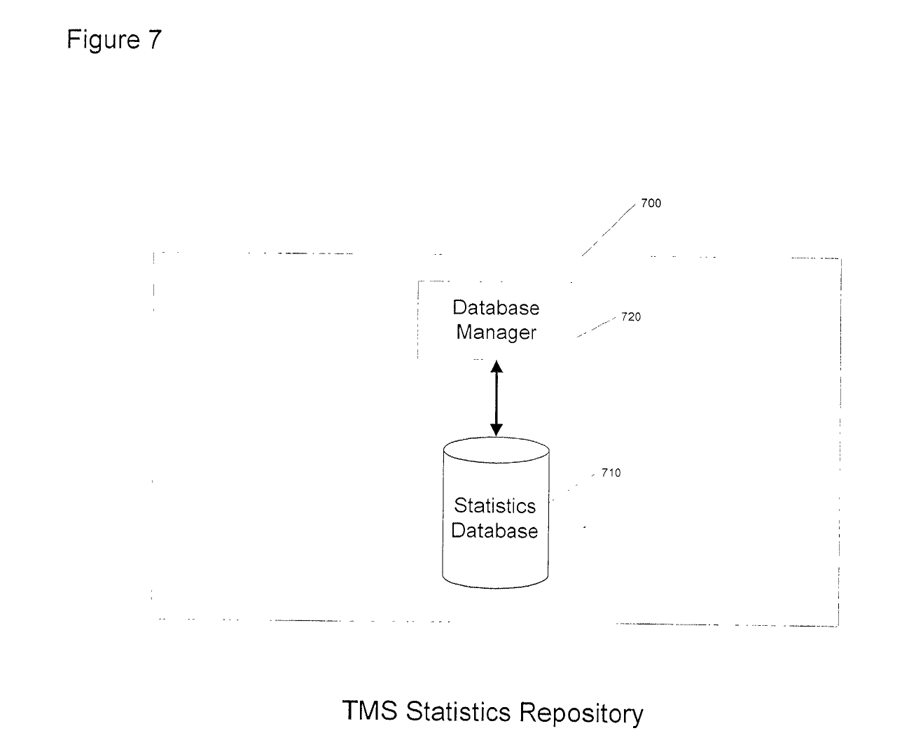

As described above, the TMS Statistics Repository acts as a collection or aggregation point for data from the TMS Statistics Collection Servers distributed throughout the network. FIG. 7 is an illustration of a TMS Statistics Repository 700 of a preferred embodiment. As shown in FIG. 7, the architecture of the TMS Statistics Repository 700 comprises a database 710 and a database manager 720. The database 710 is used to store the data (e.g., statistics) received from TMS Statistics Collection Servers 620 (or other TMS Statistics Repositories if the TMS Statistics Repositories are deployed in a hierarchical arrangement), and the database manager 720 provides a mechanism for accessing and processing the stored data. The database manager 720 and database 710 can be implemented using any commercially available database system that can handle the volume of data (e.g., Oracle Database Server). Many database managers already have the ability to accept data over a network connection, format the data into database entries, and insert it into the database. If the chosen database manager does not have these abilities, a network server application can be constructed by any programmer skilled in the art of network programming and database usage to listen to a socket, receive data in formatted packets, reformat the data into the database entry in use, and insert the data into the database using the database manager. A record within the database 710 can take the form of a time-stamped version of the NetFlow record, as shown in Table 1 above. In the preferred embodiment, the record shown in Table 1 is extended with fields listing the predicted number of packets and predicted bandwidth required by the flow for the next 5 ΔT time periods.

Once the data is stored in the TMS Statistics Repository 610, it can be further analyzed. For example, the data stored in the TMS Statistics Repository 610 can be used as input to the TMS Algorithm 200 shown in FIG. 2. It should be noted that the statistics collection functionality described here can be used alone or in combination with the embodiments described above for automatically directing data in response to traffic demands and with the embodiments described later in this document. If the TMS Algorithm or other type of automatically directing data system is used, it might be preferred to design the TMS Statistics Repository 610 to be fault tolerant. In this way, the failure of a single TMS Statistics Repository would not prevent the real-time provisioning. The TMS Statistics Repository can be made fault tolerant by a mechanism such as having the database managers replicate the database between multiple individual TMS Statistics Repositories. This is a standard feature on commercially available database managers.

There are several alternatives that can be used with this preferred embodiment. In one alternate embodiment, the TMS Statistics Collection Servers are eliminated or integrated with the TMS Statistics Repository so that all of the network elements ship monitoring information/statistics/predictions directly to a central location.

Multiplicity-of-Protocols Embodiments

In some networks, the network elements within a POP use different protocols. For example, different network elements from the same or different vendors can use different protocols (e.g. NetFlow, SNMP, TL1, or CMIP). Examples of protocols include, but are not limited to, commands or procedures for requesting data from network elements, commands for configuring network elements to report data, formats in which traffic information or statistics can be reported, or types of available data. This can present a compatibility problem that can prevent the local processor from collecting traffic information from a network element. To avoid this problem, the local processor used in the preferred embodiment to collect traffic information from the network elements is operative to collect traffic information from the network elements using their respective protocols. It should be noted that this functionality can be implemented alone or in combination with the analysis of the collected traffic information (e.g., prediction of future traffic demands), with the transmittal of the analyzed or raw data from the local processor to a remote data storage device described above, and/or with any of the other embodiments described herein.

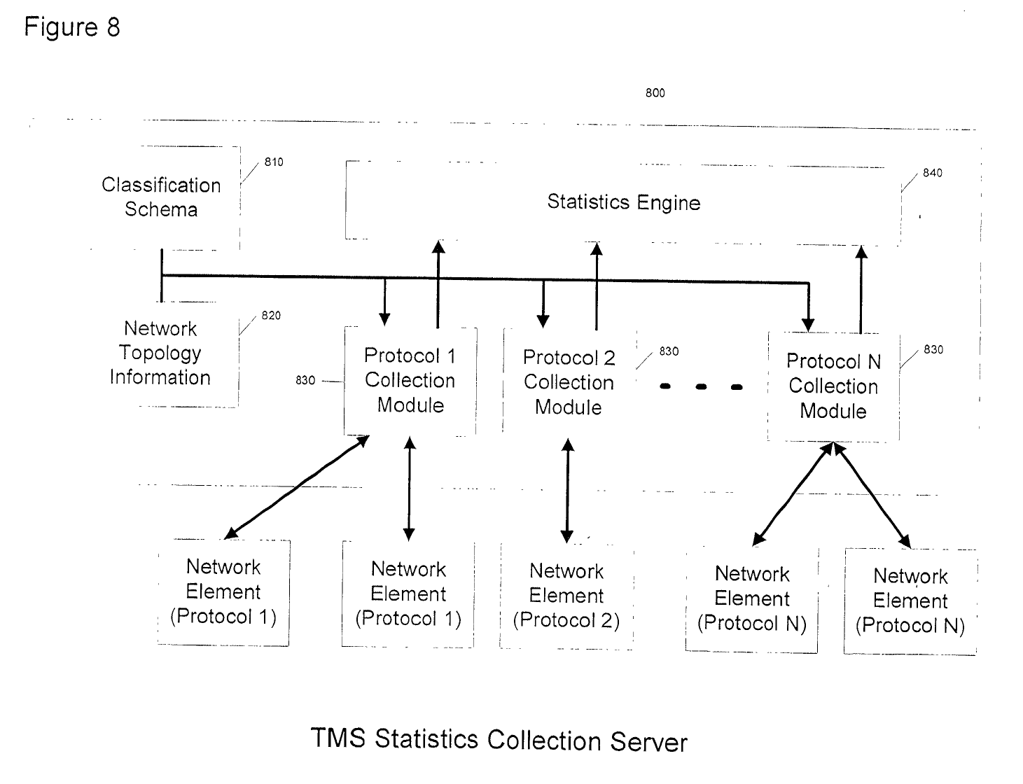

Turning again to the drawings, FIG. 8 is block diagram of a TMS Statistics Collection Server 800 of a preferred embodiment that illustrates this functionality. As shown in FIG. 8, the TMS Statistics Collection Server 800 comprises classification schema 810, network topology information 820, a plurality of protocol-specific modules 830, and a statistics engine 840. The classification schema 810 describes the information that the TMS Statistics Collection Server 800 should attempt to collect from each of the network elements listed in the network topology information 820. For each network element, the relevant portion of the classification schema 810 is provided to the appropriate protocol-specific module 830, which then communicates this information to the actual network element. The network topology information 820 allows the TMS Statistics Collection Server 800 to know where to go to collect the desired information. The network topology information 820 preferably comprises (1) a list of network elements from which a given TMS Statistics Collection Server should collect information, (2) information identifying the type of equipment (i.e., vendor and product ID) comprising each network element, and (3) information indicating how communication should take place with that network element.

The protocol-specific modules 830 (which can be vendor-specific and/or equipment-specific) know how to communicate with multiple types of network devices or multiple instances of a network device and gather desired traffic information. The protocol-specific modules translate a generic request into a specific form that will be understood by the network element. If the network element cannot respond to the request directly, the protocol-specific module preferably collects information that it can get from the network element and tries to synthesize an answer to the request that was described in the classification schema 810. In one preferred embodiment, the protocol-specific modules 830 are responsible for (1) configuring network elements to collect network statistics (this can include instructing the network elements to perform filtering on the data that they collect so that only essential data is returned to the TMS Statistics Collection Server); (2) collecting network statistics for each network element; (3) filtering the network statistics provided by each network element (in some cases, the network elements themselves may be capable of filtering the data that they present to the TMS Statistics Collection Server so that the TMS Statistics Collection Server does not need to perform any filtering functions itself); and (4) converting the statistics to a common format understood by the overall network statistics collection system. The Statistics Engine 840 aggregates the network statistics received from each of the vendor-specific modules and then transmits them to a TMS Statistics Repository (if used) for storage and processing. The TMS Statistics Collection Server 800 can also perform live packet capture, distill this information, convert it into a common format, and then transmit it to a TMS Statistics Repository.

Because a protocol-specific module is provided for each of the protocols needed to retrieve statistics or other traffic information from network elements, a single TMS Statistics Collection Server can interoperate with multiple types of equipment from multiple vendors. As a result, the network elements do not need to be provided by the same vendor, nor do they need to be of the same type (e.g., SONET ADMs, IP routers, ATM switches, etc.). In this way, a single TMS Statistics Collection Server can be enabled with the appropriate protocol modules that will allow it to simultaneously collect information from many varied network elements. For example, the TMS Statistics Collection Server can, using three separate protocol modules, process NetFlow data from a Cisco Router, process SNMP statistics from an ATM switch, and process CMIP statistics from a SONET ADM.

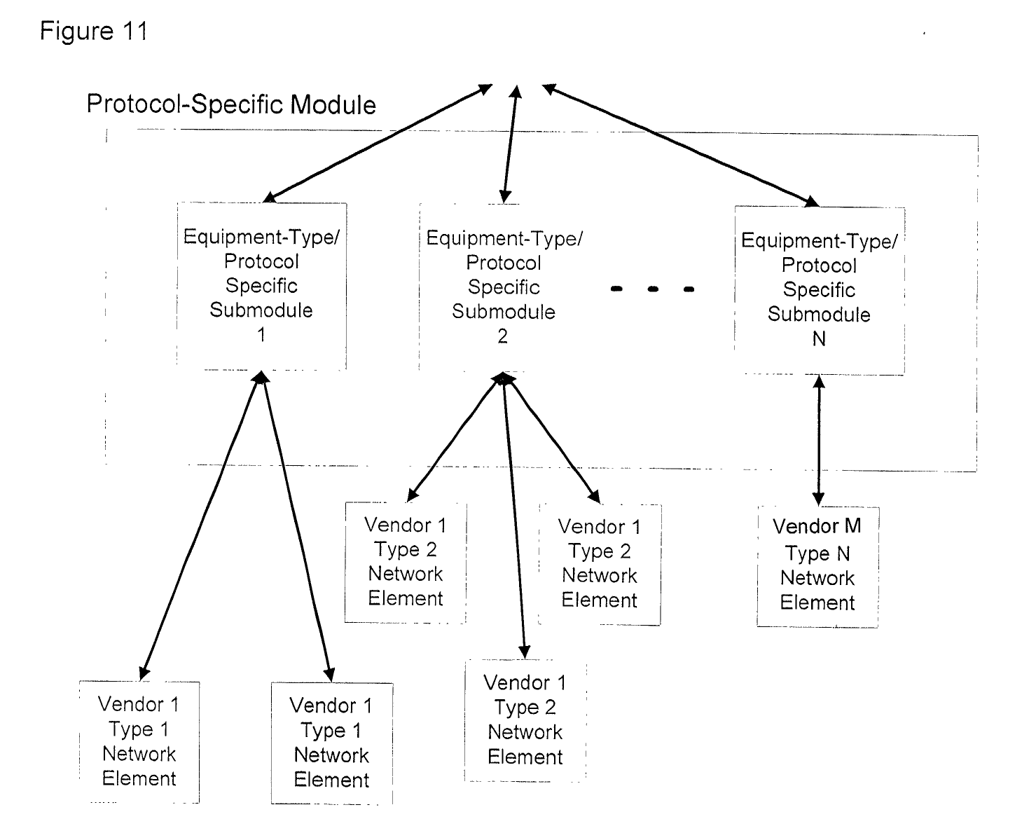

Each of these modules can also contain sub-modules that allow the TMS Statistics Collection Server to communicate with different types of network elements. Such a set of sub-modules is shown in FIG. 11. For example, if a single TMS Statistics Collection Server needs to communicate with both Vendor A's router and Vendor A's optical cross-connects, the vendor-module for Vendor A can include two sub-modules: one to interact with the router and another to interact with the cross-connect. In the event that both the router and the optical cross-connect support the same external interface to the TMS Statistics Collection Server, a single sub-module can be used to interact with both devices.

To the TMS, different types of network elements are distinguished by the protocols by which they are configured, the protocols by which they communicate, and the features that they provide. If two vendors each produce a different network element, but those network elements use the same protocols for configuration and communication and provide the same features, the TMS can treat them in the same fashion (although in certain cases, even use of the same protocol will require the TMS Signaling System use a different module to communicate with the network elements). However, if the same vendor produced two different network elements, each of which used a different protocol, the TMS would treat those two elements differently, even though they were produced by the same vendor.

The list of network elements and a mechanism for addressing/communicating with these network elements may be manually configured into the TMS Statistics Collection Server by the network operator, or it may be discovered by the TMS Statistics Collection Server if the carrier is running one or more topology discovery protocols. An example of a suitable topology discovery protocol is the Traffic Engineering extensions to the Open Shortest Path First (OSPF) routing protocol (OSPF-TE). Once the TMS Statistics Collection Server has a complete list of the network elements and a method for addressing them, it can then query each device (via SNMP, for example) to determine the type of device, the vendor, etc. This information can also be manually configured into the network topology information module.

There are several alternatives that can be implemented. For example, the TMS Statistics Collection Server can be eliminated, and a central source can query each device. Additionally, a TMS Statistics Collection Server can be required for each vendor (i.e., only one vendor-specific module per TMS Statistics Collection Server). Further, a TMS Statistics Collection Server can be required for each supported protocol (i.e., only one protocol-specific module per TMS Statistics Collection Server).

The following is an example illustrating the operation of the TMS Statistics Collection Server of this preferred embodiment. For this example, the topology information has been manually configured to list one IP router, R1, with an IP address of 1.1.1.1. The following is an example of information that can comprise a classification schema for an IP router (R1). The schema need not contain all of these fields or can contain many other fields. The example classification schema for router R1 consists of the following field(s):

1. Network Element ID

An identifier (perhaps serial number) that uniquely identifies R1

2. Network Element Address Information

IP Address of R1. This can also, for example, identify a particular ATM PVC/SVC used to communicate with R1

3. Network Equipment Vendor ID

ID indicating which vendor-specific module should interact with R1

As a result of processing the classification schema for R1, the TMS Statistics Collection Server sends one or more directives/rules to router R1. Each directive is preferably comprised of an Information Request Record and an IP Flow Description Record. The IP Flow Description Record can also be combined with one or more transport-layer flow description records, for example, a TCP flow description record or a UDP flow description record.

Information Request Record:

1. Packet receive count

2. Packet forward count

3. Data rate (e.g,. estimate of bits/second over some interval T1)

4. Max burst size (e.g., max number of packets observed over some interval T2)

IP Flow Description Record:

1. Incoming Interface Index (e.g., SNMP Index)

2. Outgoing Interface Index (e.g., SNMP Index)

3. Incoming Label (e.g., MPLS label used on incoming interface)

Outgoing Label (e.g., MPLS label used on outgoing interface)

OR

4. IP Source Address

IP Source Address Mask

IP Destination Address

IP Destination Address Mask

IP Type of Service (i.e., TOS or DIFFSERV bits)

IP Protocol (i.e., transport-layer protocol)

OR

5. Source Administrative System

Destination Administrative System

Ingress point

An IP flow record preferably consist of only 3, 4, or 5, however, any combination can be specified.

TCP Flow Description Record:

TCP Source Port

TCP Destination Port

UDP Flow Description Record:

UDP Source Port

UDP Destination Port

The classification schema can also include additional information useful to the TMS Statistics Collection Server. Examples of such information include the mapping of IP addresses to Autonomous System numbers, which is used in processing the traffic statistics to condense the statistics or to answer a classification schema including requests for IP Flow Description Records of type 5.

Network Reconfiguration Embodiments

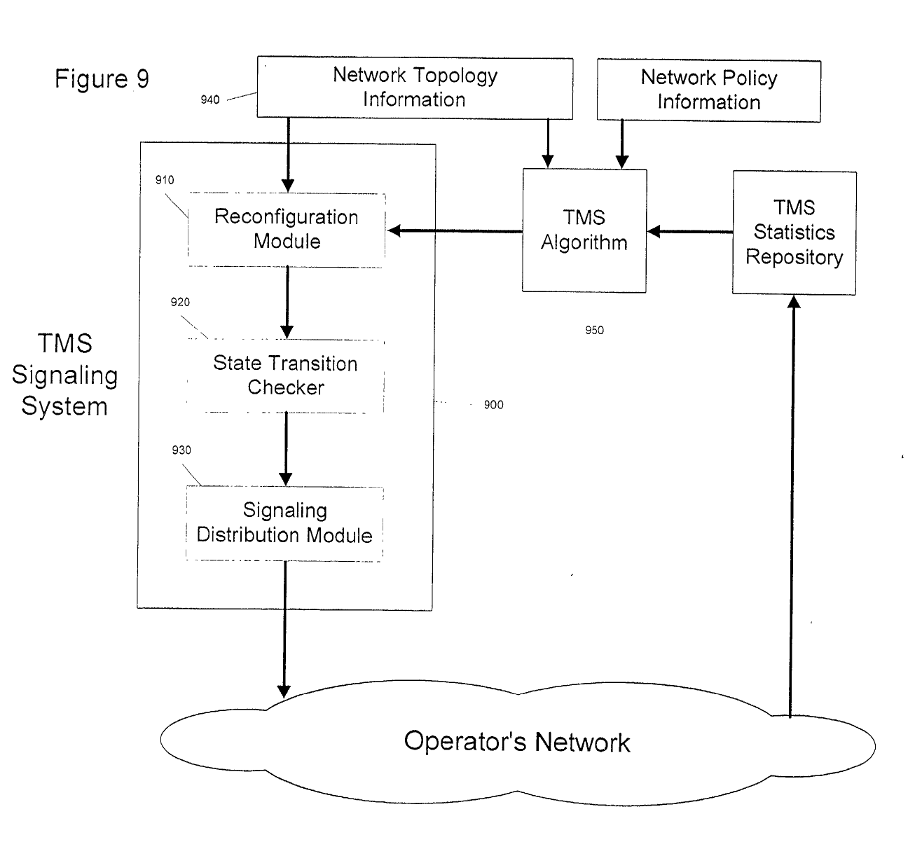

Turning again to the drawings, FIG. 9 shows the components of a TMS Signaling System 900 of a preferred embodiment. As shown in FIG. 9, this preferred TMS Signaling System 900 comprises a reconfiguration module 910, a state transition checker 920, and a signaling distribution module 930. In operation, the reconfiguration module 910 creates a series of network transformation instructions. As used herein, the term “network transformation instruction” is intended broadly to refer to any instruction that can be used to configure or reconfigure one or more network elements in a computer network to create a network configuration. Examples of network transformation instructions include, but are not limited to, instructions to establish a link, circuit, or path between nodes and instructions to tear down a link, circuit, or path.

In FIG. 9, the reconfiguration module 910 combines the network topology information 940 with the output of the TMS Algorithm 950 to create a configuration for each of the network elements represented in the network topology. This topology is described in a common format used by the system. The configuration is preferably not converted to equipment/vendor-specific configurations until after the configuration is processed by the state transition checker 920. An acceptable common format for the system is the complete set of Command Language Interface (CLI) commands defined by a common router vendor, such as the Cisco CLI. The network topology can be determined by any number of methods. For example, the network operator can run a routing protocol such as OSPF or ISIS (possibly with Traffic Engineering (TE) extensions). The network operator can also assemble the configured files for each of the IP routers in the network and using the information contained therein to construct a graph of the network topology.

The state transition checker 920 determines whether the series of network transformation instructions is valid (e.g., that the state transitions induced by a network configuration or reconfiguration do not result in intermediate states that prevent later states from being reached). In this way, the state transition checker 920 acts as a “sanity check” to make sure that everything happens in an orderly fashion. When reviewing a network configuration, the state transition checker 920 ensures that the order in which network elements are configured does not create undesirable intermediate states in the network. For example, when reconfiguring an optical cross-connect, it might be possible to partition a portion of the network from the TMS Signaling System 900 if network element configurations are executed in the wrong order. The state transition checker 920 orders the configuration steps to ensure that the network configuration can be implemented completely and without destabilizing the network. The state transition checker 920 can be implemented as a network simulator that establishes an ordering for the network element re/configuration instructions and then simulates the behavior of each of these instructions to ensure correctness and stability. The initial ordering for the reconfiguration instructions is the order that results from the execution of the TMS algorithm as described above. If this ordering is found to cause incorrectness or instability, the order is permuted so that the failing step is placed first. Several iterations of this method will typically result in an acceptable order. Examples of suitable network simulators include the NetMaker product from Make Systems and the simulator described in “IP Network Configuration for Traffic Engineering” by Anja Feldman and Jennifer Rexford, ATT TR-000526-02, May 2000, which is hereby incorporated by reference.

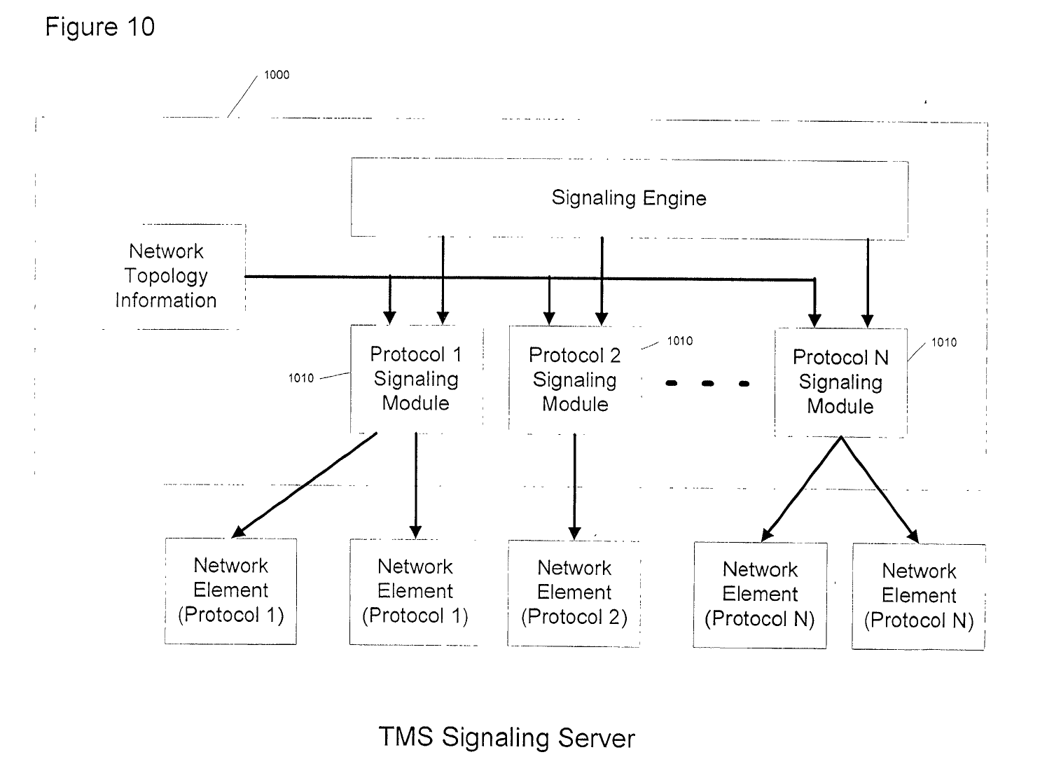

When the state transition checker 920 verifies a valid series of instruction, the instructions are sent to the signaling distribution module 930. The signaling distribution module 930 is responsible for ensuring that each of the network elements is properly configured. In operation, the distribution module 930 distributes the configuration information to the local TMS Signaling Servers in the order determined by the state-transition checker 920. If the signaling distribution module 930 communicates directly with each of the network elements, the protocol-specific modules described above can be implemented to convert the description of the configuration produced by the reconfiguration module 910 into specific instructions that are understood by each of the network elements. Alternatively and preferably, the signaling distribution system 930 can send the configuration for each network element to the appropriate TMS Signaling Server, such as the TMS Signaling Server 1000 shown in FIG. 10. The protocol-specific modules 1010 on the TMS Signaling Server 1000 can then convert the generic configuration information into the appropriate commands that are understood by each network element.

Carriers may wish to offer levels of preferential service having a specific SLA to customers willing to pay a premium. This preferential service is delivered by provisioning private paths in the network. Every path calculated by the TMS Algorithm in response to a request for service constitutes a private path, as the TMS Algorithm will arrange the traffic in the network such that any constraints expressed by the request are satisfied. Examples of constraints include bandwidth, latency, packet loss rate, and scheduling policy. A Virtual Private Network is a specific type of a private path.

Appendix I and Appendix II contain text of Matlab code. This code can be run on any computer capable of supporting the Matlab package sold by The Mathworks, Inc. The preferred computer is a high-end Intel-based PC running the Linux operating system with a CPU speed greater than 800 MHz. Conversion of the code from Matlab M-Files to C code can be achieved via the use of The Mathworks M-File to C compiler. Such a conversion may be desirable to reduce the running time of the code. The code shown in Appendix I provides a presently preferred implementation of the TMS Algorithm, the creation and use of network topology information, the use of traffic demand retrieved from predictions in the TMS Statistics Repository, and the creation of path specifications that serve as input to the TMS Signaling System. The code shown in Appendix II provides a presently preferred implementation of the network topology information creation. In the preferred embodiment, the TMS Signaling System runs on the same hardware that implements the TMS Algorithm. The Network Policy Information and Network Topology Information can be entered or discovered by processes running on the same hardware as the TMS Algorithm, or on a separate management console computer. The management console computer is preferably a high-end PC workstation with a large monitor running the linux operating system.

The preferred embodiment of the TMS Statistics Collection Server is a commercially-available rack-mountable computer having: an Intel Pentium Processor with a CPU clock speed of 1 GHz or greater, linux or FreeBSD operating system, 20 GB or more local disk space, and at least one 100 Mbps Ethernet port.

The preferred embodiment of the TMS Statistics Repository is an UltraSPARC server as manufactured by Sun Microsystems with a RAID storage subsystem managed by Oracle Database Server.

It is intended that the foregoing detailed description be understood as an illustration of selected forms that the invention can take and not as a definition of the invention. It is only the following claims, including all equivalents, that are intended to define the scope of this invention.

[image]

[image]

[image]

[image]

[image]

[image]

[image]

[image]

[image]

[image]

[image]

[image]

[image]

What is claimed is:

1. A method for configuring a network element in a computer network, the method comprising:
(a) receiving an instruction to configure a network element in a computer network;
(b) converting the instruction into a form understood by the network element; and
(c) sending the converted instruction to the network element.

2. The invention of claim 1 further comprising receiving at least one additional instruction to configure at least one additional network element in the computer network, converting the at least one additional instruction into a form understood by the at least one additional network element, and sending the converted at least one additional instruction to the at least one additional network element.

3. The invention of claim 2, wherein the first-mentioned network element and the at least one additional network element are same type devices from different vendors.

4. The invention of claim 2, wherein the first-mentioned network element and the at least one additional network element are different type devices from different vendors.

5. The invention of claim 2, wherein the first-mentioned network element and the at least one additional network element are different type devices from same vendors.

6. The invention of claim 2, wherein the first-mentioned instruction and the at least one additional instruction are arranged in a first order, and wherein the invention further comprises:
determining whether the first-mentioned instruction and the at least one additional instruction will result in an invalid network state of the computer network if implemented in the first order; and
if the first-mentioned instruction and the at least one additional instruction will result in an invalid network state of the computer network if implemented in the first order, rearranging the first-mentioned instruction and the at least one additional instruction into an order that will not result in an invalid network state if implemented.

7. The invention of claim 6, wherein the determining and rearranging acts are performed before the first-mentioned instruction and the at least one additional instruction are converted.

8. The invention of claim 6, wherein the determining and rearranging acts are performed after the first-mentioned instruction and the at least one additional instruction are converted.

9. The invention of claim 1 further comprising generating the instruction to configure the network element based on a traffic demand of the computer network.

10. The invention of claim 9, wherein the instruction to configure the network element is generated based on a predicted traffic demand of the computer network.

11. The invention of claim 9, wherein the traffic demand is determined at least in part from traffic data from a plurality of network elements in the computer network.

12. The invention of claim 9, wherein the traffic demand is determined at least in part from traffic data predicted from a plurality of network elements in the computer network.

13. The invention of claim 9, wherein the traffic demand is determined at least in part from a request.

14. The invention of claim 13, wherein the request is expressed in terms of one or more of the following: bandwidth, latency, jitter, loss rate, protection type, and burst size.

15. The invention of claim 13, wherein the request is expressed using RSVP.

16. The invention of claim 13, wherein the request is expressed using RSVP-TE.

17. The invention of claim 13, wherein the request is expressed using a user-to network interface.

18. The invention of claim 13, wherein the request expresses a service level agreement.

19. The invention of claim 18, wherein the request expresses a service level agreement that allows a customer to reserve a private path

20. The invention of claim 19, wherein the request expresses a service level agreement that allows a customer to reserve a protection path in addition to the private path.

21. The invention of claim 9, wherein the traffic demand is determined at least in part from a policy system.

22. The invention of claim 21, wherein the policy system comprises a policy expressed in terms of one or more of the following: bandwidth, latency, jitter, loss rate, protection type, and burst size.

23. The invention of claim 21, wherein the policy system is implemented using COPS.

24. The invention of claim 21, wherein the policy system expresses a service level agreement that allows a customer to reserve a private path

25. The invention of claim 21, wherein the policy system expresses a service level agreement that allows a customer to reserve a protection path in addition to the private path.

26. A system for configuring a network element in a computer network, the system comprising:
a network element in a computer network; and
a processor operative to receive an instruction to configure the network element, convert the instruction into a form understood by the network element, and send the converted instruction to the network element.

27. The system of claim 26 further comprising at least one additional network element in the computer network, and wherein the processor is further operative to receive at least one additional instruction to configure the at least one additional network element, convert the at least one additional instruction into a form understood by the at least one additional network element, and send the converted at least one additional instruction to the at least one additional network element.

28. The invention of claim 27, wherein the first-mentioned network element and the at least one additional network element are same type devices from different vendors.

29. The invention of claim 27, wherein the first-mentioned network element and the at least one additional network element are different type devices from different vendors.

30. The invention of claim 27, wherein the first-mentioned network element and the at least one additional network element are different type devices from same vendors.

31. The invention of claim 27, wherein the first-mentioned instruction and the at least one additional instruction are arranged in a first order, and wherein the processor is further operative to:
determine whether the first-mentioned instruction and the at least one additional instruction will result in an invalid network state of the computer network if implemented in the first order; and
if the first-mentioned instruction and the at least one additional instruction will result in an invalid network state of the computer network if implemented in the first order, rearrange the first-mentioned instruction and the at least one additional instruction into an order that will not result in an invalid network state if implemented.

32. The invention of claim 31, wherein the processor is operative to perform the determining and rearranging acts before converting the first-mentioned instruction and the at least one additional instruction.

33. The invention of claim 31, wherein the processor is operative to perform the determining and rearranging acts after converting the first-mentioned instruction and the at least one additional instruction.

34. The invention of claim 26 further comprising an additional processor operative to generate the instruction to configure the network element based on a traffic demand of the computer network.

35. The invention of claim 34, wherein the instruction to configure the network element is generated based on a predicted traffic demand of the computer network.

36. The invention of claim 34, wherein the traffic demand is determined at least in part from traffic data from a plurality of network elements in the computer network.

37. The invention of claim 34, wherein the traffic demand is determined at least in part from traffic data predicted from a plurality of network elements in the computer network.

38. The invention of claim 34, wherein the traffic demand is determined at least in part from a request.

39. The invention of claim 38, wherein the request is expressed in terms of one or more of the following: bandwidth, latency, jitter, loss rate, protection type, and burst size.

40. The invention of claim 38, wherein the request is expressed using RSVP.

41. The invention of claim 38, wherein the request is expressed using RSVP-TE.

42. The invention of claim 38, wherein the request is expressed using a user-to network interface.

43. The invention of claim 38, wherein the request expresses a service level agreement.

44. The invention of claim 43, wherein the request expresses a service level agreement that allows a customer to reserve a private path.

45. The invention of claim 44, wherein the request expresses a service level agreement that allows a customer to reserve a protection path in addition to the private path.

46. The invention of claim 34, wherein the traffic demand is determined at least in part from a policy system.

47. The invention of claim 46, wherein the policy system comprises a policy expressed in terms of one or more of the following: bandwidth, latency, jitter, loss rate, protection type, and burst size.

48. The invention of claim 46, wherein the policy system is implemented using COPS.

49. The invention of claim 46, wherein the policy system expresses a service level agreement that allows a customer to reserve a private path

50. The invention of claim 46, wherein the policy system expresses a service level agreement that allows a customer to reserve a protection path in addition to the private path.

51. A system for configuring a network element in a computer network, the system comprising:
means for receiving an instruction to configure a network element in a computer network;
means for converting the instruction into a form understood by the network element; and
means for sending the converted instruction to the network element.
